(19) United States
(12) Patent Application Publication
(10) Pub. No.: US 2003/0200361 A1
(43) Pub. Date: Oct. 23, 2003

(54) Extensible drive

(76) Inventors: Vikas Dogra, Irvine, CA (US); Manoj Verma, Irvine, CA (US); Ashutosh Gjiare, Irvine, CA (US); Sanjay Wangoo, Irvine, CA (US); George Koppich, Irvine, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/126,718

(22) Filed: Apr. 19, 2002

(51) Int. Cl. G06F 3/00

(52) U.S. Cl. 710/8

(57) ABSTRACT

A system and method for document distribution that only requires a single generic driver on a computer workstation. When a destination is selected, the generic driver searches the computer workstation's registry and executes a dynamic link library for obtaining the data necessary for the output to be processed by the destination. The generic driver then sends the output to a server which parses the file and formats the output so that it can be processed by the destination and forwards the output to the destination.

### BACKGROUND OF THE INVENTION

The present invention relates generally to document distribution and more particularly to a module that provides the capability to send a document to multiple destinations.

Typically when sending an output to a device, a driver for that device must be loaded on the computer workstation that is sending the output. A driver is software program that enables other programs to work with a particular device without concerning themselves with the specifics of the device's hardware and internal language. In the case where a computer workstation is connected to several devices, a separate device driver is required for each device. In the case of a network where the output devices may be shared, the driver for each device must be loaded on each computer workstation on the network. When the driver software is updated, then each computer workstation on the network must be upgraded which can be a time consuming administrative task, especially on large networks.

It is often desirable to send an output to multiple destinations. Often the destinations are different devices, such as a fax, e-mail, and printer. Normally, a user at a computer workstation would have to manually send the output to each device as each device has a different driver and requires different input parameters to direct the output. For example, a fax machine typically needs the telephone number of the destination, a network printer may need information for a cover page, and an e-mail program may need the e-mail address of the recipients.

Thus a need exists for a simple method that enables a computer workstation to easily send an output to multiple destinations. It is also desirable to ease the administrative overhead by only requiring a computer workstation to use a single driver to interface with the output devices.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### BRIEF SUMMARY OF THE INVENTION

In view of the aforementioned needs, the invention contemplates a method and system wherein a single generic driver is installed on a computer workstation for handling all output requests. For each output device, there is a dynamic link library, for example GUI.DLL, available on the computer workstation for obtaining the necessary parameters needed by the output device. The generic driver obtains the location of the particular dynamic link library via the computer workstation's system registry.

Once an output is requested, the generic driver is invoked. The generic driver requests a destination for the output. Upon receiving a destination, the generic driver searches the system registry for a dynamic link library associated with the selected output destination. The dynamic link library is then executed and obtains parameters necessary for the output destination device and stores them in a file. The generic printer driver then reads the file with the stored parameters and generates an output file containing the output and commands based on the parameters for the server to process the output file. The output file is then sent to the server. The server then parses the output file, processes the file like a driver so that the output is in the proper format for the destination, and then sends the output to the selected destination.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### BRIEF DESCRIPTION OF THE SEVERAL VIEWS OF THE DRAWING

The drawings illustrate the best mode presently contemplated of carrying out the invention.

FIG. 1 is a block diagram of the preferred embodiment of the system of the present invention;

FIG. 2 is a block diagram of the steps of the method of the present invention.

### DETAILED DESCRIPTION OF INVENTION

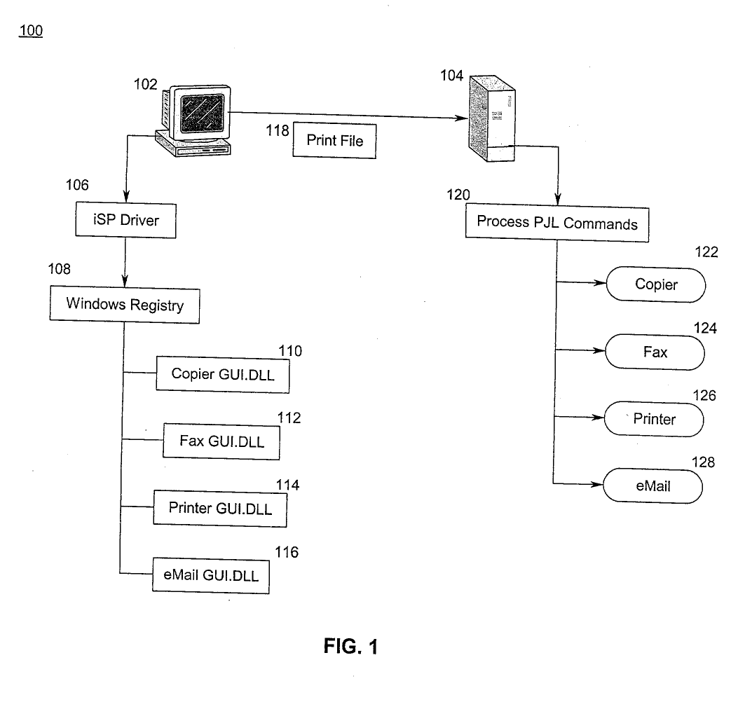

Referring to FIG. 1, there is shown a system, generally designated 100, for utilizing the present invention. The system comprises a computer workstation 102 and a server 104 that are communicatively coupled to each other.

The computer workstation 102 comprises a generic printer driver 106. The generic driver 108 is capable of generating an output with commands that can be parsed by the server 104. The server 104 then re-formats the output into the appropriate format for the destination.

The generic driver 106 obtains the parameters necessary for the output destination by calling the appropriate dynamic link library. The generic driver 108 searches the system registry 108 to obtain the location of the appropriate dynamic link library. As shown in FIG. 1, the registry 108 has locations for a copier dynamic link library 110, a fax dynamic link library 112, printer dynamic link library 114 and e-mail dynamic link library 116. Additional output devices may be made available to the computer workstation 102 by adding dynamic link libraries to the computer workstation 102 and storing the location of the library in the registry 108. It is also contemplated that multiple output devices of the same type may be installed on the computer workstation 102. For example, multiple printers are suitably used by having a separate dynamic link library stored in the registry 108 of the computer workstation 102. Each printer's dynamic link library would contain information on the printer, such as location, queue, manufacturer and other pertinent information.

After the generic driver 106 has obtained the necessary information from the various dynamic link libraries, a print file 118 is generated. Commands that may be parsed by the server are inserted into the print file 118 which is then sent to the server 104. The server using either software, hardware or a combination thereof, parses the commands as shown in block 120. The output is then directed to the appropriate destination with the necessary commands to operate the output device such as a copier 122, fax 124, printer 126 or e-mail 128.

While in FIG. 1 the various output devices are shown separately, as those skilled in the art can readily appreciate, the present invention is compatible with multifunctional peripherals which may include, but are not limited to, one or more of a copier, facsimile machine, printer, and an e-mail server, and combinations thereof.

Because the generic driver 102 calls dynamic link libraries to obtain the necessary parameters, it is not necessary for each output device to have a driver installed on the computer workstation 102. Whenever a new output device is added, it is only necessary to add a new dynamic link library on the computer workstation 102. The generic driver 102 sends the print file 118 to the file which then acts as the driver for the output destination. In the preferred embodiment, the server 104 is an iSP server and the generic driver 106 is an iSP driver.

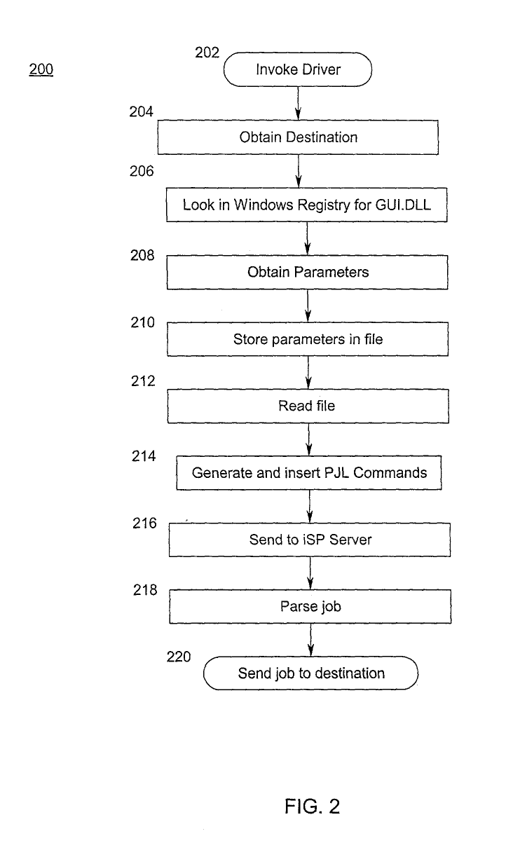

Referring now to FIG. 2 there is shown the method of the present invention generally designated 200. The method begins by invoking the printer driver as shown in step 202. At step 204 the printer driver then obtains the destination of the output. The generic driver 106 then searches the system registry 108 as shown in step 206 for the dynamic link library associated with the selected destination. The dynamic link library then obtains the parameters for the destination device as shown in step 208. After the dynamic link library obtains the parameters, the parameters are temporarily stored as shown in step 210. At step 212 the generic driver 106 reads the parameters which were temporarily stored in step 210. If more than one destination is specified, the parameters may stored in a separate file for each destination, or all the parameters may be stored in a single file. Then at as 214, the generic printer driver generates a print file 118 and inserts a command into the print file 118. In the preferred embodiment, the driver inserts PJL commands into the print file 118. At step 216 the print file 118 is sent to the server 104. At step 218 the server 104 parses the print file 118. Upon parsing the print file 118, the server 104 converts the output to a format that is compatible with the destination. At step 218 the server 104 sends the job to the destination.

As contemplated by the present invention, the server 104 acts as a driver for each output destination. The server 104 parses the print file and reads commands from the print file that are generated by the generic driver, and translates the commands and output to a format readable by the output destination. Thus, only the generic print driver 106 that is compatible with the server 104 is necessary at the computer workstation 102, along with dynamic link libraries for obtaining the required parameters for each output device. For example, a copier dynamic link library would obtain information such as number of copies, where to staple the copies, or special papers that need to be printed such as tabbed paper or letterhead. The fax dynamic link library would obtain fax cover page information such as sender and recipient data and telephone numbers. The printer dynamic link library would obtain information such as which printer, queue, number of copies and other options or features available for the selected printer. The e-mail dynamic link library would obtain information such as recipient's e-mail addresses, subject line for the e-mail, or an accompanying message.

It is also contemplated that the system and method of the present invention can be utilized to send outputs to a multiplicity of destinations. A user at the computer workstation 102 may select multiple output destinations which would cause the generic driver 106 to execute the dynamic link library for each output destination. Upon completion of the execution of all of the necessary dynamic link libraries, the generic driver 106 would then build either a single print file 118 having a command for each output destination inserted into the print file 118 or the generic driver 106 would send a separate print file 118 for each destination. Building a separate print file is preferred as it would save bandwidth and processing time by the server 104.

Although the invention has been shown and described with respect to a certain preferred embodiment, it is obvious that equivalent alterations and modifications will occur to others skilled in the art upon the reading and understanding of this specification. The present invention includes all such equivalent alterations and modifications and is limited only by the scope of the following claims.

What is claimed is:

1. A method of sending an output having a destination from a computer workstation to the destination via a server communicatively coupled to the computer workstation and the destination, the destination being communicatively coupled to the server, the steps comprising:
executing a generic driver at the computer workstation;
designating the destination for the output;
obtaining a parameter for the destination;
storing the output and parameter in a file;
generating an output file and inserting a command responsive to the parameter into the output file;
sending the output file to the server; and
delivering the output to the destination in accordance to the commands stored in the output file.

2. The method of claim 1, wherein the obtaining a parameter step further comprises:
searching a registry for a dynamic link library associated with the destination; and
running the dynamic link library, wherein the dynamic link library obtains the parameter and stores the parameter in the file.

3. The method of claim 1, wherein the generating step further comprises reading the file by the generic driver.

4. The method of claim 1, wherein the delivering step further comprises parsing the output file by the server.

5. The method of claim 1 wherein the operating system of the computer workstation is selected from the group consisting of Windows 95, Windows 98, Windows NT, Windows ME, and Windows 2000.

6. The method of claim 1 further comprising
designating a second destination for the output, the second destination being communicatively coupled to the server;
searching the registry for a dynamic link library associated with the second destination;
executing the second dynamic link library;
obtaining a second parameter for the second destination;
storing the second parameter in a second file;
inserting into the output file a second command responsive to the second parameter; and
delivering the output to the second destination in accordance to the second command stored in the output file.

7. A method of sending an output having a destination from a computer workstation to the destination via a server communicatively coupled to the computer workstation and the destination, the steps comprising:
providing a generic driver at the computer workstation;
executing the driver by the computer workstation;
designating the destination for the output;
searching a registry for a dynamic link library associated with the destination;
running the dynamic link library;
obtaining parameters for the destination;
storing the output and parameters in a file;
reading the file by the generic driver;
generating and inserting a command into an output file;
sending the output file to the server;
parsing the output file by the server;
delivering the output to the destination in accordance to the commands stored in the output file.

8. The method of claim 7 wherein the operating system of the computer workstation is selected from the group consisting of Windows 95, Windows 98, Windows NT, Windows ME, and Windows 2000.

9. The method of claim 7 further comprising
designating a second destination for the output;
searching the registry for a dynamic link library for the second destination;
executing the second dynamic link library;
obtaining a second parameter for the second destination;
storing the second parameter in a second file;
inserting into the output file a second command responsive to the second parameter; and
delivering the output to the second destination in accordance to the second command stored in the output file.

10. The method of claim 7 wherein the command in the generating and inserting step is a PJL command.

11. A system for producing an output, comprising:
a computer workstation having a generic driver, the generic driver suitably adapted to accessing a registry on the computer workstation, the registry providing the generic driver with a location of a dynamic link library;
a server communicatively coupled to the computer workstation; and
an output device at the destination communicatively coupled to the server, the output device being at least one of the group consisting of a copier, a printer, a facsimile machine, and an email processor;
wherein the generic driver receives input for selecting the output device, the generic driver then accessing the registry and obtaining the location a dynamic link library associated with the output device, the dynamic link library obtaining a parameter necessary for the output device to properly handle the output, the dynamic link library creating a file;
wherein upon creation of the file, the generic driver reads the file, creates a print file and inserts a command responsive to the parameter into the print file and sends the print file to the server; and
wherein the server upon receipt of the print file, parses the file and delivers the file to the output device in accordance to the command stored within the file.

12. The system of claim 11 further comprising a second output device selected from the group consisting of a copier, a printer, a facsimile machine, and an email processor communicatively coupled to the server; and
wherein, prior to sending the print file to the server, the generic driver receives input for selecting the second output device, the generic driver then accessing the registry and obtaining a location for a second dynamic link library associated with the second output device, the second dynamic link library obtaining a second parameter necessary for the second output device to properly handle the output, the appropriate dynamic link library creating a second file;
wherein upon creation of the second file, the generic driver reads the second file and inserts a command responsive to the second parameter into the print file, and sends the file to the server.

13. The system of claim 11 wherein the operating system of the computer workstation is selected from the group consisting of Windows 95, Windows 98, Windows NT, Windows ME, and Windows 2000.

14. The system of claim 11 wherein the server is an iSP server.

15. The system of claim 14 wherein the generic driver is an iSP driver.

16. A computer readable medium of instructions, comprising
means for generating an output and executing a generic driver at the computer workstation;
means for designating a destination;
means for searching a registry for a dynamic link library associated with the destination;
means for running the dynamic link library and obtaining a parameter for the destination;
means for storing the output and the parameter in a file;
means for generating a command responsive to the parameter and inserting the command into the output file;
means for sending the output file to the server; and
means for the server to deliver the output to the destination in accordance to the command stored in the output file.

17. The computer readable instructions of claim 16 further comprising
means for designating a second destination;
means for searching the registry for a second dynamic link library associated with the second destination;
means for executing the second dynamic link library and obtaining a parameter for the second destination; and
means for generating and inserting a second command into the output file responsive to the second parameter;
wherein the second command is inserted into the output file prior to sending output file to the server.

18. A computer software product that includes a medium readable by a processor, the medium having stored thereon:
a first sequence of instructions which, when executed by said processor causes said processor to generate an output and execute a generic driver at the computer workstation;
a second sequence of instructions which, when executed by said processor causes said processor to designate a destination;
a third sequence of instructions which, when executed by said processor causes said processor to search a registry for a dynamic link library associated with the destination;
a fourth sequence of instructions which, when executed by said processor causes said processor to run the dynamic link library and obtaining parameters for the destination;
a fifth sequence of instructions which, when executed by said processor causes said processor to store the output and parameters in a file;
a sixth sequence of instructions which, when executed by said processor causes said processor to generate and insert commands into an output file;
a seventh sequence of instructions which, when executed by said processor causes said processor to send the output file to the server; and
an eighth sequence of instructions which, when executed by said processor causes said processor to deliver the output to the destination in accordance to the commands stored in the output file.

19. A computer program product having a computer readable medium having computer program logic recorded thereon for producing an output, comprising:
means for providing a generic driver at the computer workstation;
means for executing the driver by the computer workstation;
means for designating the destination;
means for looking in a registry for a dynamic link library for the destination;
means for running the dynamic link library, the dynamic link library obtaining a parameter for the destination;
means for storing the output and parameter in a file;
means for reading the file by the generic driver;
means for generating and inserting a command, the command responsive to the parameter, into the output file;
means for sending the output file to a server;
means for parsing the output file by the server;
means for delivering the output to the destination in accordance to the command stored in the output file.

20. A computer program product having a computer readable medium having computer program logic recorded thereon for producing an output, comprising:
means adapted to providing a generic driver at the computer workstation;
means adapted to executing the driver by the computer workstation;
means adapted to designating the destination;
means adapted to searching a registry for a dynamic link library associated with the destination;
means adapted to running the dynamic link library, the dynamic link library obtaining a parameter for the destination;
means adapted to storing the output and parameter in a file;
means adapted to reading the file by the generic driver;
means adapted to generating an output file and inserting a command responsive to the parameter into the output file;
means adapted to sending the output file to a server;
means adapted to parsing the output file by the server;
means adapted to delivering the output to the destination in accordance to the command stored in the output file.
